(19) United States
(12) Patent Application Publication
(10) Pub. No.: US 2015/0237319 A1
(43) Pub. Date: Aug. 20, 2015

(54) PROJECTION SYSTEM AND PROJECTION METHOD THEREOF

(71) Applicants: Wen-Wei Tsai, Hsin-Chu (TW); Tung-Yi Lu, Hsin-Chu (TW); Chun-Chin Chang, Hsin-Chu (TW); Shun-Tai Chen, Hsin-Chu (TW); Kun-Liang Jao, Hsin-Chu (TW)

(72) Inventors: Wen-Wei Tsai, Hsin-Chu (TW); Tung-Yi Lu, Hsin-Chu (TW); Chun-Chin Chang, Hsin-Chu (TW); Shun-Tai Chen, Hsin-Chu (TW); Kun-Liang Jao, Hsin-Chu (TW)

(73) Assignee: CORETRONIC CORPORATION, Hsin-Chu (TW)

(21) Appl. No.: 14/520,348

(22) Filed: Oct. 22, 2014

(30) Foreign Application Priority Data
Feb. 19, 2014 (TW) 103105541

(51) Int. Cl. H04N 9/31; G06F 3/042; G03B 21/60; G03B 21/00; G03B 21/20

(52) U.S. Cl. CPC H04N 9/3197; G03B 21/005; G03B 21/208; G03B 21/60; G06F 3/0421

(57) ABSTRACT

A projection system and a projection method thereof are provided. A plurality of image source signals is combined into a combination image signal. A host is instructed to provide a plurality of the projection ratios corresponding to the image source signals according to extended display identification data. An image source signal combination unit combines the projection ratios corresponding to the image source signals to form a combination projection ratio corresponding to the combination image signal. A light valve is set to a mode corresponding to the combination projection ratio. The illumination beam is converted to an image beam according to the combination image signal.

### CROSS-REFERENCE TO RELATED APPLICATION

This application claims the priority benefit of Taiwan application Ser. No. 103105541, filed on Feb. 19, 2014. The entirety of the above-mentioned patent application is hereby incorporated by reference herein and made a part of this specification.

### BACKGROUND

### Technical Field

The invention relates to a display apparatus. Particularly, the invention relates to a projection system and a projection method thereof

### Related Art

Presently, two or more than two projectors are generally used to implement ultrawide screen (such as 16:6) projection in a combination manner, and a transfer box is additionally provided to divide an image signal, and the divided image signals are respectively transmitted to the projectors to implement projection image combination. Since images projected by the projectors used for projection image combination may have differences in color temperature or brightness, etc., one of the projectors is taken as an adjustment reference of the projected images, so that the color of the combined projected image can be consistent. However, quality of the projected image has to be sacrificed, and additional devices have to be used to assist calibrating the combined image each time when the projection image combination is performed, which results in a waste of manpower and time.

Patents related to projection system are U.S. Patent No. 20120206695, No. 20130290416, U.S. Pat. No. 7,667,815, U.S. Pat. No. 8,550,913, China Patent No. 100383602 and No. 201984452.

### SUMMARY

The invention is directed to a projection system and a projection method, by which a single projection device is provided to project an ultrawide combination projection image corresponding to a plurality of divided images without compression distortion, where the divided images correspond to a plurality of different image source signals.

Other objects and advantages of the invention are further illustrated by the technical features broadly embodied and described as follows.

In order to achieve one or a portion of or all of the objects or other objects, an embodiment of the invention provides a projection system including a projection plane, an image source signal combination unit and a projection device, where the image source signal combination unit is coupled to a host, and receives a plurality of image source signals from the host, and combines and converts the image source signals into a combination image signal. The projection device includes a light source, a light valve, a storage unit and a control unit. The light source is used for providing an illumination beam. The light valve is disposed on a transmission path of the illumination beam, and has a light receiving surface, where the light receiving surface converts the illumination beam into an image beam for projecting to the projection plane to form a combination image, where the combination image corresponds to the combination image signal. The storage unit stores extended display identification data and a resolution mode lookup table. The control unit is coupled to the light valve, the storage unit and the image source signal combination unit, and provides the extended display identification data to the host to instruct the host to provide a plurality of projection ratios corresponding to the image source signals.

In an embodiment of the invention, the image source signal combination unit combines the projection ratios corresponding to the image source signals to form a combination projection ratio, and controls the light valve to convert the illumination beam into the image beam according to the combination image signal, and the control unit further sets the light value to a mode corresponding to the combination projection ratio according to the resolution mode lookup table, so that the combination image is complied with the combination projection ratio.

In an embodiment of the invention, the projection device further includes an integration rod disposed on the transmission path of the illumination beam and located between the light source and the light valve, and the integration rod has a light incident end and a light emitting end, where the illumination beam enters the integration rod through the light incident end and leaves the integration rod through the light emitting end, and an aspect ratio of the light emitting end of the integration rod is complied with the combination projection ratio.

In an embodiment of the invention, an area of the light incident end is greater than or equal to an area of the light emitting end.

In an embodiment of the invention, the combination projection ratio is between 2.3:1 and 2.7:1.

In an embodiment of the invention, the ultrawide projection ratio is between 2.3:1 and 2.7:1.

In an embodiment of the invention, when the light value is set to a mode corresponding to the ultrawide projection ratio, the control unit disables a part of region of the light receiving surface, so that a non-disabled region of the light receiving surface is complied with the ultrawide projection ratio, and the non-disabled region of the light receiving surface is used for receiving the illumination beam from the light emitting end.

In an embodiment of the invention, the combination image is combined by a plurality of images corresponding to the image source signals.

In an embodiment of the invention, the projection system further includes a touch module, and the touch module includes at least one detection light source and a light sensing unit. The detection light source is used for emitting a detection beam to detect the projection plane. The light sensing unit is coupled to the host, and senses a reflected light of the detection beam reflected by an input tool, and the host determines a touch position of the input tool according to the reflected light.

In an embodiment of the invention, the host further defines a touch region and a non-touch region on the projection plane.

In an embodiment of the invention, the non-touch region displays a first image projected by the projection device, and the touch region displays a second image projected by the projection device, wherein the first image and the second image correspond to the image source signals.

In an embodiment of the invention, the touch region displays a blank image.

In an embodiment of the invention, the projection system further includes a light emitting unit and an invisible light sensing unit. The light emitting unit simultaneously emits a visible light and an invisible light to form a light spot on the projection plane. The invisible light sensing unit is coupled to the host, and senses the invisible light, and the host determines a position of the light spot according to a sensing result of the invisible light sensing unit.

In an embodiment of the invention, the host is further connected to a cloud server through a network interface.

In an embodiment of the invention, the projection plane is a screen, and the screen includes a Fresnel lens film or smart glass.

In an embodiment of the invention, the light source includes a light-emitting diode, a laser light source or a high-pressure mercury lamp.

In an embodiment of the invention, the light valve is a digital micromirror device (DMD) or a liquid crystal on silicon (LCOS) panel.

In an embodiment of the invention, the projection device is spaced from the projection plane by a distance of 30-50 cm, and the combination image projected by the projection device is above 130 inches.

The invention provides a projection method of a projection system, which include following steps. A plurality of image source signals is received. The image source signals are combined and converted into a combination image signal. Extended display identification data is transmitted to a host to instruct the host to provide a plurality of projection ratios corresponding to the image source signals, so as to form a combination projection ratio. An image beam is projected to a projection plane to form a combination image complied with the combination projection ratio.

In an embodiment of the invention, the projection method further includes setting a light valve to a mode corresponding to the combination projection ratio according to a resolution mode lookup table.

In an embodiment of the invention, the projection method further includes following steps. An integration rod is provided and disposed on a transmission path of an illumination beam, and the integration rod has a light incident end and a light emitting end, where the illumination beam enters the integration rod through the light incident end and leaves the integration rod through the light emitting end. The light valve is controlled to convert the illumination beam leaving the integration rod into the image beam according to the combination image signal.

In an embodiment of the invention, the projection method further includes following steps. The combination image corresponding to the combination image signal is provided, where the combination image is formed by combining a plurality of images corresponding to the image source signals.

In an embodiment of the invention, an area of the light incident end is greater than or equal to an area of the light emitting end, the illumination beam enters the integration rod through the light incident end, and leaves the integration rod through the light emitting end, and an aspect ratio of the light emitting end is complied with the combination projection ratio.

In an embodiment of the invention, the combination projection ratio is between 2.3:1 and 2.7:1.

In an embodiment of the invention, the light valve has a light receiving surface, the light receiving surface converts the illumination beam into the image beam, when the light valve is set to a mode corresponding to the combination projection ratio, a part of region of the light receiving surface is disabled, so that a non-disabled region of the light receiving surface is complied with the combination projection ratio.

In an embodiment of the invention, the projection method further includes following steps. The projection plane is provide, where the projection plane is defined into a touch region and a non-touch region, the combination image projected to the projection plane is divided into a first image and a second image respectively corresponding to the non-touch region and the touch region, and the first image and the second image correspond to the image source signals.

According to the above descriptions, in the embodiment of the invention, a plurality of image source signals are converted into the combination image signal, and the illumination beam is output through the integration rod with the aspect ratio of the light emitting end thereof complying with the ultrawide projection ratio, and the extended display identification data is provided to the host to instruct the host to provide the combination image signal corresponding to the ultrawide projection ratio. Meanwhile, the light valve is set to the mode corresponding to the ultrawide projection ratio, and the light valve is controlled by the combination image signal to convert the illumination beam into the image beam capable of projecting the ultrawide projection image complied with the ultrawide projection ratio, so as to provide the ultrawide projection image without compression distortion. In this way, a size of the projected image that is originally achieved by two projection devices now can be achieved by a single projection device.

Other objectives, features and advantages of the invention will be further understood from the further technological features disclosed by the embodiments of the invention wherein there are shown and described preferred embodiments of this invention, simply by way of illustration of modes best suited to carry out the invention. In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1-1 is a schematic diagram of a projection system according to an embodiment of the invention.

FIG. 1-2 is a schematic diagram of a projection system according to an embodiment of the invention.

FIG. 1-3 is a schematic diagram of a projection system according to an embodiment of the invention.

FIG. 1-4 is a schematic diagram of a projection system according to an embodiment of the invention.

FIG. 2-1 is a schematic diagram of a projection system according to another embodiment of the invention.

FIG. 2-2 is a schematic diagram of a projection system according to another embodiment of the invention.

FIG. 2-3 is a schematic diagram of a projection system according to another embodiment of the invention.

FIG. 2-4 is a schematic diagram of a projection system according to another embodiment of the invention.

FIG. 3 is a flowchart illustrating a projection method of a projection system according to an embodiment of the invention.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations.

As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

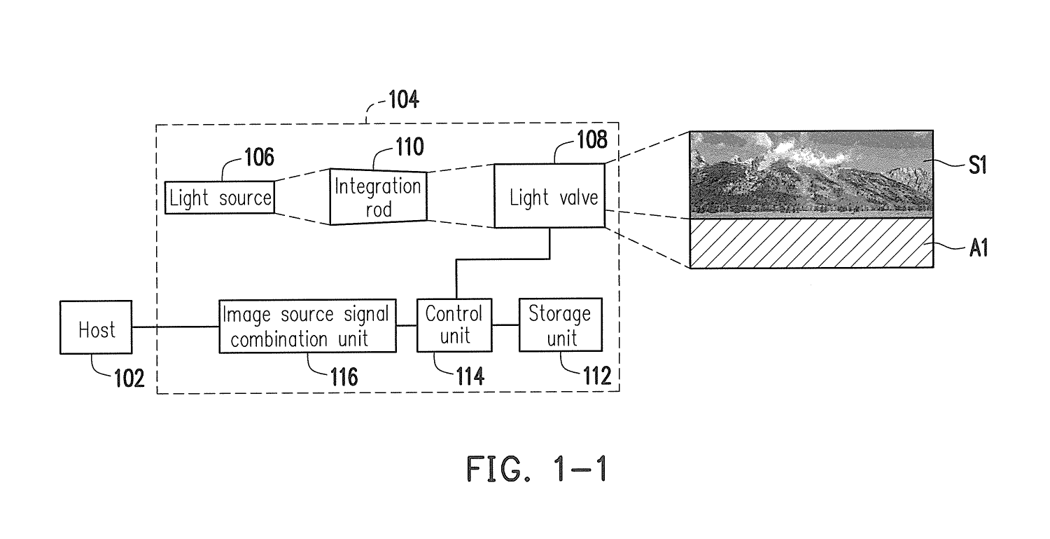

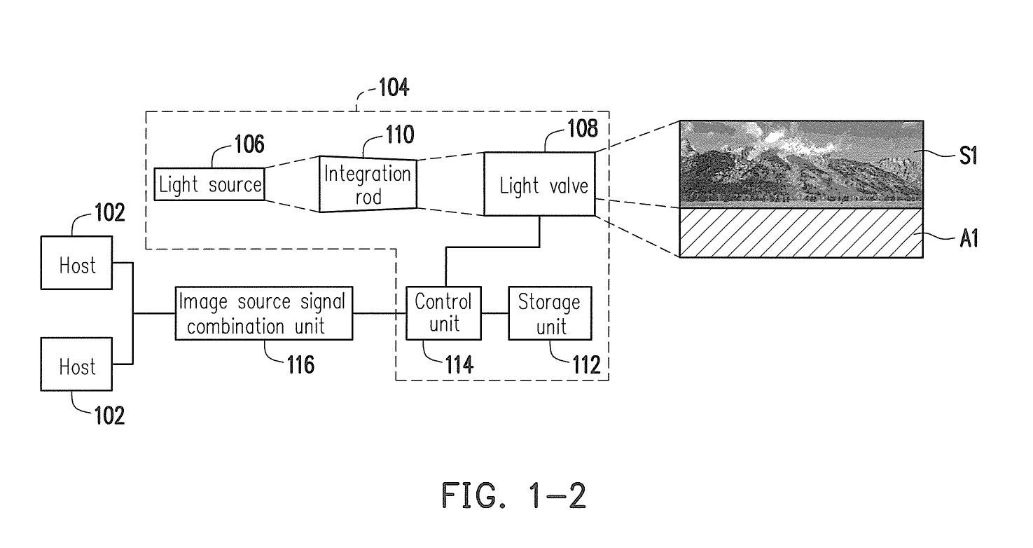

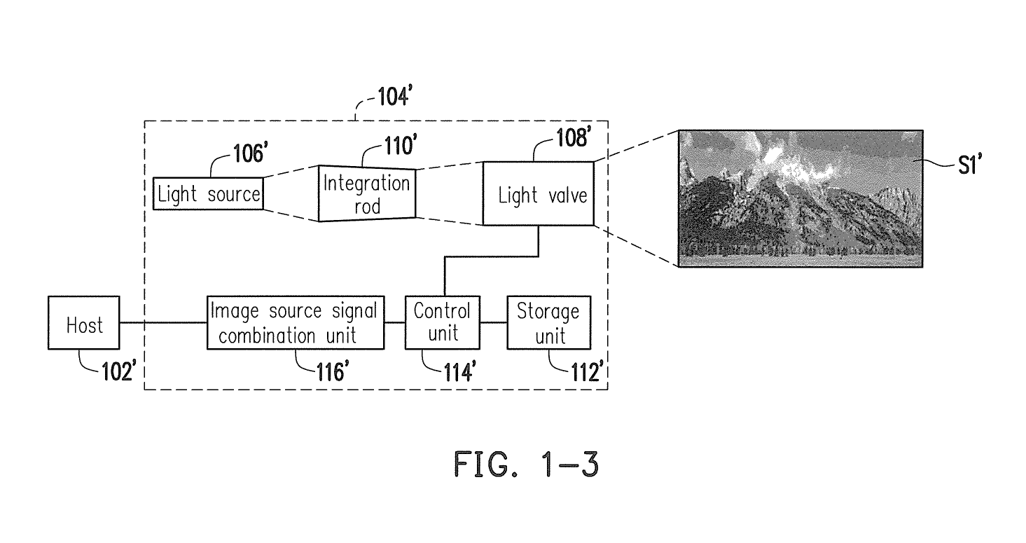

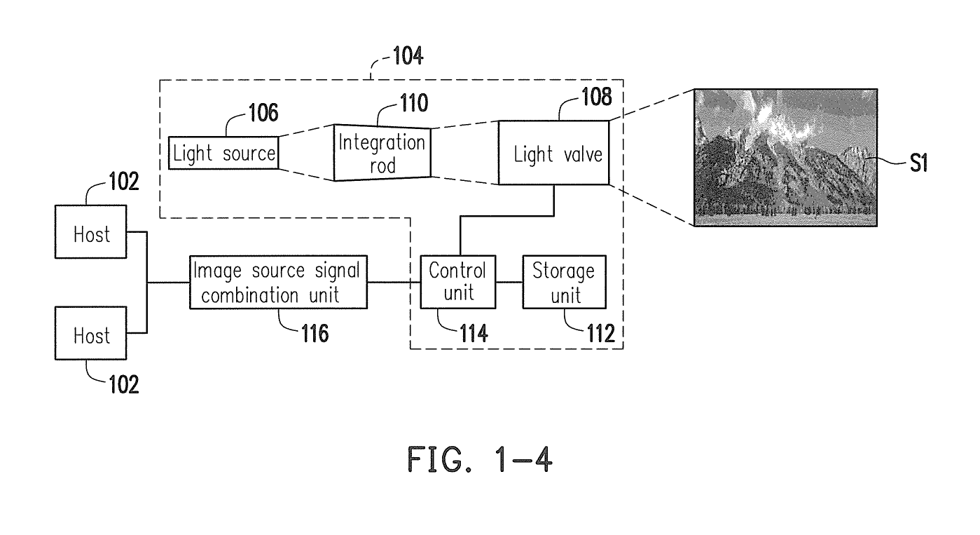

FIG. 1-1 is a schematic diagram of a projection system according to an embodiment of the invention. Referring to FIG. 1-1, the projection system includes a projection plane S1 and a projection device 104. The projection device 104 may include a light source 106, a light valve 108, an integration rod 110, a storage unit 112, a control unit 114 and an image source signal combination unit 116. The control unit 114 is coupled to the light valve 108, the storage unit 112 and the image source signal combination unit 116. The storage unit 112 is used for storing extended display identification data (EDID), and the EDID may include information such as a highest resolution, a scan frequency, manufacture's name and serial number, etc. of the projector device 104. The projection device 104 is adapted to be coupled to the host 102, where the host 102 is, for example, an electronic device capable of providing image data such as a computer, a tablet PC or a mobile phone, etc.

Moreover, the image source signal combination unit 116 may simultaneously receive a plurality of image source signals from the host 102, where the image source signals represent a source with output images, which is not limited to a single host 102 or multiple hosts, and the image source signal combination unit 116 combines and converts the image source signals into a combination image signal, where an image corresponding to the combination image signal is combined by a plurality of images corresponding to the aforementioned image source signals. For example, projection ratios originally presented by two image source signals are all 4:3, and a combination projection ratio of the combination image generated by the image source combination unit 116 is 16:6, though the invention is not limited thereto, and the required combination projection ratio of the combination image can be defined by a user. Moreover, a plurality of images corresponding to the image source signals have different projection ratios or resolutions, which can be combined by the image source signal combination unit 116 to generate the combination projection ratio of the combination image according to the projection ratio preset by the user. When the projection device 104 is connected to the host 102, the host 102 requires the projection device 104 to provide the EDID, and the control unit 114 in the projection device 104 provides the EDID stored in the storage unit 112 to the host 102, such that the host 102 provides a plurality of projection ratios corresponding to the image source signals, and the image source signal combination unit 116 combines the projections ratios corresponding to the image source signals to form a combination projection ratio, which corresponds to the combination image signal of the combination projection ratio to be projected. For example, in the embodiment, the projection deice 104 is used for projecting an ultrawide image (the combination image) with an ultrawide projection ratio (the combination projection ratio), where the ultrawide image is combined by the images corresponding to the image source signals. The ultrawide image is an image having the ultrawide projection ratio, and the ultrawide projection ratio is, for example, between 2.3:1 and 2.7:1, and an optimal ultrawide projection ratio is 16:6 or 21:9, though the invention is not limited thereto.

The light source 106 is used for providing an illumination beam, the light source 106 is, for example, a light-emitting diode (LED), a laser light source or a high-pressure mercury lamp, though the invention is not limited thereto. The integration rod 110 is disposed on a transmission path of the illumination beam, and is located between the light source 106 and the light valve 108.

The integration rod 110 has a light incident end and a light emitting end. The integration rod 110 can receive the illumination beam from the light source 106 through the light incident end and output the illumination beam through the light emitting end, where an area of the light incident end of the integration rode 110 is greater than an area of the light emitting end, and an aspect ratio of the light emitting end is complied with the ultrawide projection ratio. In this way, the illumination beam can be more convergent to effectively increase projection brightness and improve projection quality. It should be noticed that in other embodiments, the area of the light incident end of the integration rode 110 can also be equal to the area of the light emitting end, which is not limited by the invention.

The light valve 108 is, for example, a digital micromirror device or liquid crystal on silicon panel, which is disposed on the transmission path of the illumination beam. After the illumination beam is output through the light emitting end of the integration rod 110, the illumination beam is incident to the light valve 108. The light valve 108 has a light receiving surface, and the control unit 114 controls the light receiving surface of the light valve 108 to convert the illumination beam incident to the light receiving surface into an image beam according to the image signal provided by the host 102 or the combination image signal provided by the image source signal combination unit 116, and the image beam is projected to the projection plane S1 to form the ultrawide image. The projection plane S1 is, for example, a screen including a Fresnel lens film, which is capable of directing the projection beam to a viewer to increase color enhancement and contrast, or the projection plane S1 is a screen having a wiping feature. The screen can also be smart glass, which may present a transparent state or a fog white state according to different applied voltages to serve as a projection screen. In other words, the screen can be a reflective, translucent or transmissive screen.

Moreover, the storage unit 112 can also store a resolution mode lookup table storing ultrawide image resolutions such as 1920×720, 1280×550, 2560×1080, etc., though the invention is not limited thereto, and the required resolutions can be set by manufacturers. When the control unit 114 controls the light receiving surface of the light valve 108 to convert the illumination beam according to the combination image signal, the control unit 114 can look up a mode corresponding to the ultrawide projection ratio according to the resolution mode lookup table stored in the storage unit 112, and sets the light valve 108 to the mode corresponding to the ultrawide projection ratio (or resolution), so that an image signal format provided by the host 102 is compatible to the projection device 104. When the light valve 108 is set to the mode corresponding to the ultrawide projection ratio, the control unit 114 disables a part region of the light receiving surface of the light valve 108, so that the non-disabled region of the light receiving surface is complied with the ultrawide projection ratio, and the non-disabled region of the light receiving surface can be used to receive the illumination beam from the light emitting end of the integration rod 110. Regarding the disabling operation of the control unit 114, if the light valve is a digital micromirror device, digital micromirrors of a part region of the light receiving surface of the light valve are controlled to be not actuated according to an electric signal, such that the illumination beam is not projected to the projection plane through a wide-angle lens, for another example, if the light valve is an LCOS panel, regarding the disabling operation of the control unit 114, liquid crystal molecules of a part region of the light receiving surface of the light valve are controlled by an electric signal to achieve an effect that the illumination beam cannot pass there through or reflected by this part of region to form the image beam, in this way, by disabling a part region of the light receiving surface of the light valve 108, the image beam corresponding to a region Al (an oblique line region of FIG. 1) without projection is shielded, such that the ratio of the projected image is ensured to be complied with the ultrawide projection ratio.

As described above, the image source signal combination unit 116 converts a plurality of image source signals into the combination image signal, and the illumination beam is output through the integration rod with the aspect ratio of the light emitting end thereof complying with the ultrawide projection ratio, and the EDID is provided to the host to instruct the host to provide the combination image signal corresponding to the ultrawide projection ratio. Meanwhile, the light valve is set to the mode corresponding to the ultrawide projection ratio, and the light valve is controlled by the combination image signal to convert the illumination beam into the image beam capable of projecting the ultrawide projection image complied with the ultrawide projection ratio.

The projection device of the invention used in collaboration with an ultra-short focus wide-angle projection lens can construct an ultra-short focus wide-angle projector, which may project the image beam onto the projection plane S1 to form the ultrawide image including divided images corresponding to the image source signals, where each of the divided images presents a non-compression distortion state, and a projection ratio of the projection device 104 can be smaller than 0.4 (for example, 0.35, 0.25, 0.18), where the projection ratio is defined as a ratio of a distance between the projection device and the projection plane relative to a width of a projection image on the projection plane. For example, a projection image with an original resolution of 1920×1080 and a projection image ratio of 16:9 is projected through the projection system of the aforementioned embodiment, and an ultrawide projection image with a resolution of 1920×720 and a projection image ratio of 16:6 is obtained, or an ultrawide projection image with a resolution of 1920×822, 2560×1080, 1280×550 and a projection image ratio of 21:9 is obtained. Therefore, the single projector can also project an ultrawide projection image of more than 130 inches (the projection image ratio 16:6) or 150 inches (the projection image ratio 21:9) when the distance between the projector and the projection plane is between 30 cm and 50 cm, so as to avoid the problems of the conventional technique of low image brightness and waste of adjusting time due to usage of a plurality of projectors and image distortion caused by image compression.

In another embodiment of the invention, the light valve is an LCOS panel, and is used in collaboration with a lens array to sever as a light uniform device for providing the illumination beam, where the lens array has the same function as that of the integration rod, and has a light incident surface and a light emitting surface equivalent to the light incident end and the light emitting end of the integration rod. In brief, an aspect ratio of the light emitting surface of the lens array is complied with the ultrawide projection ratio, and the lens array is used for outputting the illumination beam to the LCOS panel.

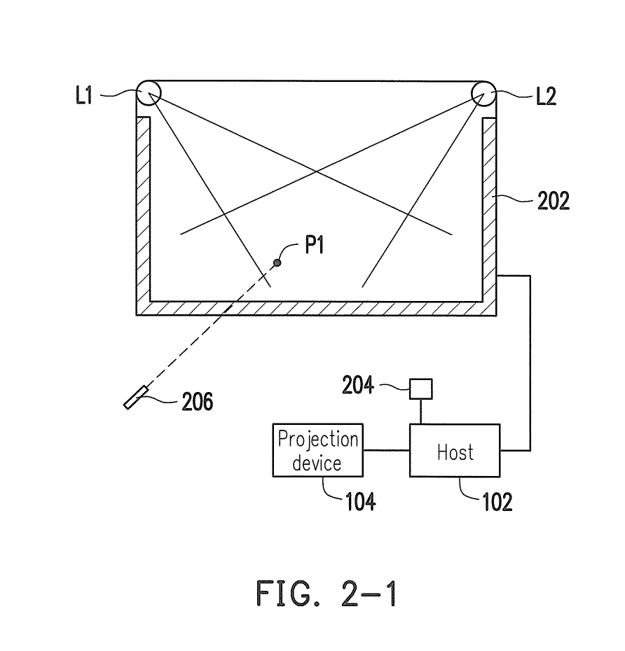

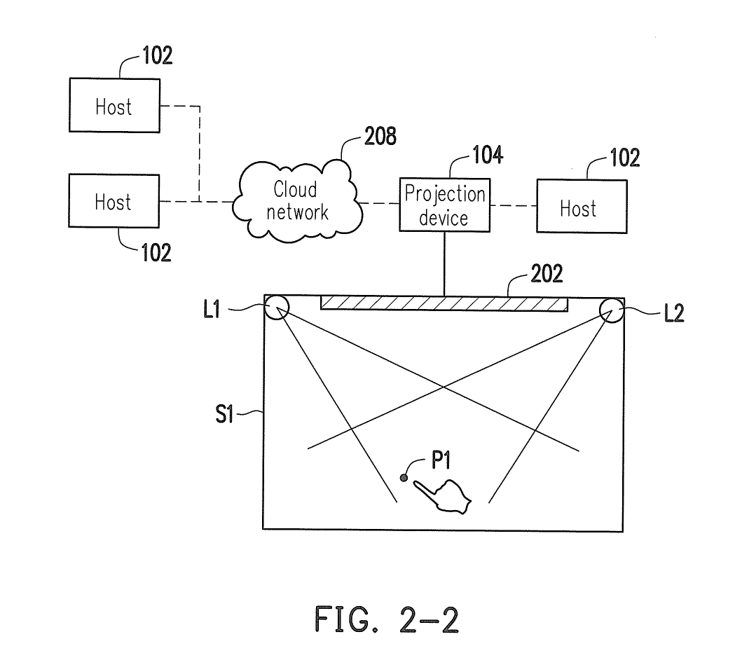

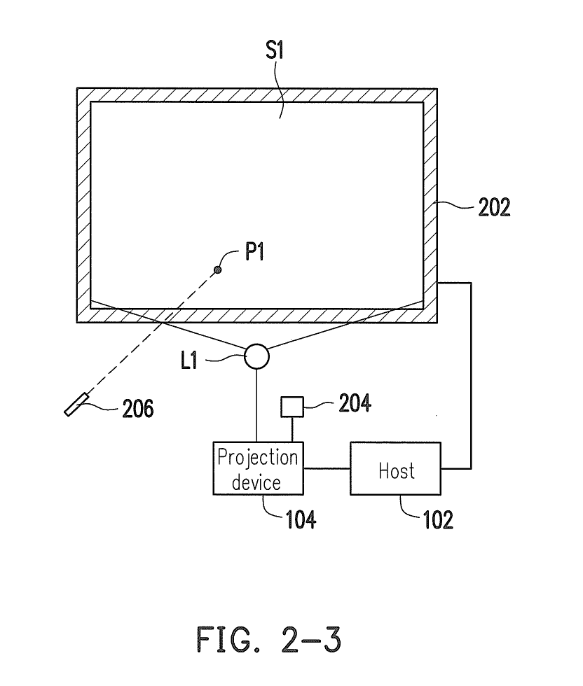

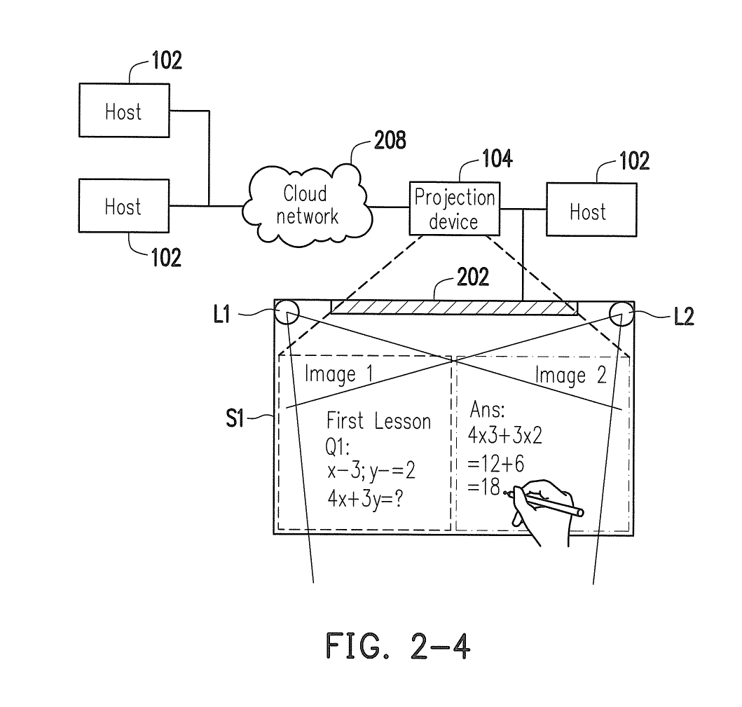

Moreover, FIG. 1-3 is a schematic diagram of a projection system according to another embodiment of the invention. Referring to FIG. 1-3, a structure of the projection system of the embodiment is similar to that of the embodiments of FIG. 1-1 and FIG. 1-2, and a difference there between is that the projection apparatus 104′ includes a light source 106′, a light valve 108′ and an integration rod 110′, where an aspect ratio of the light valve 108′ is the same as an aspect ratio of the integration rod 110′, and when the control unit 114′ controls the light receiving surface of the light valve 108′ to convert the illumination beam according to the combination image signal, the control unit 114′ can look up a mode corresponding to the ultrawide projection ratio according to the resolution mode lookup table stored in the storage unit 112′, and sets the light valve 108′ to the mode corresponding to the ultrawide projection ratio (or resolution), so that an image signal format provided by the host 102′ is compatible to the projection device 104′. When the light valve 108′ is set to the mode corresponding to the ultrawide projection ratio, the control unit 114′ enables the light receiving surface of the light valve 108′, so that the light receiving surface is complied with the ultrawide projection ratio, and the light receiving surface can be used to receive the illumination beam from the light emitting end of the integration rod 110′, so as to ensure the ratio of the projection image projected to the projection plane S′ to be complied with the ultrawide projection ratio.

Moreover, referring to FIG. 1-4. a structure of the projection system of the other embodiment of the invention is similar to that of the embodiments of FIG. 1-1 and FIG. 1-2, and a difference there between is that the storage unit 112 of the projection device 104 stores image resolutions known by those skilled in the art, for example, 600×480 VGA (video graphics array), 800×600 SVGA (super video graphics array), 1920×1080 Full-HD and 3840×2160 4K2K, though the invention is not limited thereto. The image source signal combination unit 116 can receive a plurality of image source signals from the host 102, where the image source signals represent a source with output images, which is not limited to a single host 102 or multiple hosts 102, and the image source signal combination unit 116 combines and converts the image source signals into a combination image signal, where an image corresponding to the combination image signal is combined by a plurality of images corresponding to the aforementioned image source signals. For example, projection ratios originally presented by two image source signals are 4:3, and a combination projection ratio of the combination image generated by the image source combination unit 116 can be 4:3, 16:9 or 16:10, though the invention is not limited thereto, and the required combination projection ratio of the combination image can be defined by a user. Moreover, a plurality of images corresponding to the image source signals have different projection ratios or resolutions, which can be combined by the image source signal combination unit 116 to generate the combination projection ratio of the combination image according to the projection ratio preset by the user.

Regarding application of the projection system of the invention, the aforementioned projection systems capable of projecting an ultrawide image without projection distortion and including divided images corresponding to a plurality of image source signals may have a variety of applications. For example, the projection systems of the invention can be used to project ultrawide projection images at places such as station halls, business fairgrounds, etc. It is unnecessary to use multiple projectors to combine the projection images, and only a single projection device can be used to achieve the same effect. For another example, when the projection system is used in home to enjoy movies, a same level of visual effect with that of cinema is reached to achieve better user experience. Moreover, the single projection device of the projection system of the invention can project divided images come from different image source signals, or divided images of a plurality of image source signals in a single host 102. For example, based on a multi-window function of the host 102, information of different windows can be provided to the image source signal combination unit 116 to achieve the ultrawide projection window image. For another example, the projection system can be disposed behind a screen to serve as a digital signage through rear projection, and an ultrawide projection image is projected onto a projection plane to achieve an advertising effect. For still another example, by displaying video game images through the ultrawide images projected by the projection system, the video game images are more vivid, and the image size is greater, and in case of a multiplayer game, a divided image of each player can be correspondingly displayed without a problem of image compression distortion, so that the game can be more fun in competition. Game images corresponding to two different players can be displayed at the left and right of the projection plane, and in case that the ratio of the ultrawide image is 16:6, the ratio of the two game images can be the conventional 4:3, such that the image compression distortion is completely avoided. In some embodiments, the host 102 can also be connected to a cloud server (cloud network) 208 through a network interface, and the network interface is, for example, a wired network interface or a wireless network interface. In this way, when the projection system is used for briefing, the projected images can be transmitted to other hosts, for example, mobile devices of people participating the meeting (such as mobile phones, tablet PCs, notebook computers, etc.) through the cloud server, so as to facilitate smooth proceeding of the meeting. Moreover, images of a plurality of briefings can be simultaneously displayed on the projection plane through divided images, such that data relevant to each other and dispersed in different briefings can be simultaneously displayed on the projection plane, so as to facilitate the user conveniently carry on the briefing. The projection device can be installed with an Android OS platform to facilitate directly connecting the mobile devices (such as mobile phones, tablet PCs, notebook computers, etc.) through a wireless/wired manner.

FIG. 2-1 is a schematic diagram of a projection system according to another embodiment of the invention. Referring to FIG. 2-1, a difference between the projection system of the embodiment and the projection system of the embodiment of FIG. 1-1 is that the projection system of the embodiment further includes a touch device, and the touch device includes detection light sources L1, L2 and a light sensing unit 202.

The detection light sources L1 and L2 are used for emitting detection beams to detect the projection plane S1. The light sensing unit 202 is coupled to the host 102, and in the embodiment, the light sensing unit 202 is located at side edges of the projection plane Si to form a U-shape configuration, and the light sensing unit 202 can sense the light blocked by a touch object (for example, a finger, a stylus or other object capable of blocking or reflecting the detection beams) or sense reflected lights of the detection beams reflected by the touch object, and the host 102 determines a touch position of the touch object according to a sensing result of the light sensing unit 202. It should be noticed that the number of the detection light sources is not limited by the invention, and in other embodiments, a single detection light source or more detection light sources can be used to implement detection of the projection plane S1.

The projection system of the embodiment further includes a light emitting unit 206, which is, for example, a laser pen capable of emitting a visible light, where the visible light emitted by the light emitting unit 206 forms a light spot P1 on the projection plane S1 to indicate a position pointed by the light emitting unit 206. In this way, when the user uses the light emitting unit 206 to perform a remote operation, the other viewers can also view the position and a motion of the light spot P1, so as to facilitate multiple people to discuss in collaboration. The detection beam is, for example, an infrared light or other invisible light, and the light sensing unit 202 is, for example, an infrared camera or other light sensors capable of detecting the corresponding invisible light.

FIG. 2-2 is a schematic diagram of another projection system according to the embodiment of the invention. The projection system of the embodiment further includes a touch device, and the touch device includes detection light sources L1, L2 and a light sensing unit 202. Moreover, the projection device 104 can be connected to a cloud network 208 through a wired/wireless manner and communicate with other remote hosts 102 to transmit image information. The detection light sources L1 and L2 are used for emitting detection beams to detect the projection plane S1. The light sensing unit 202 is coupled to the host 102, and in the embodiment, the light sensing unit 202 is configured at a side edge of the projection plane S1, and the light sensing unit 202 can sense the light blocked by a touch object (for example, a finger, a stylus or other object capable of blocking or reflecting the detection beams) or sense reflected lights of the detection beams reflected by the touch object, and the host 102 determines a touch position of the touch object according to a sensing result of the light sensing unit 202. It should be noticed that the number of the detection light sources is not limited by the invention, and in other embodiments, a single detection light source or more detection light sources can be used to implement detection of the projection plane S1.

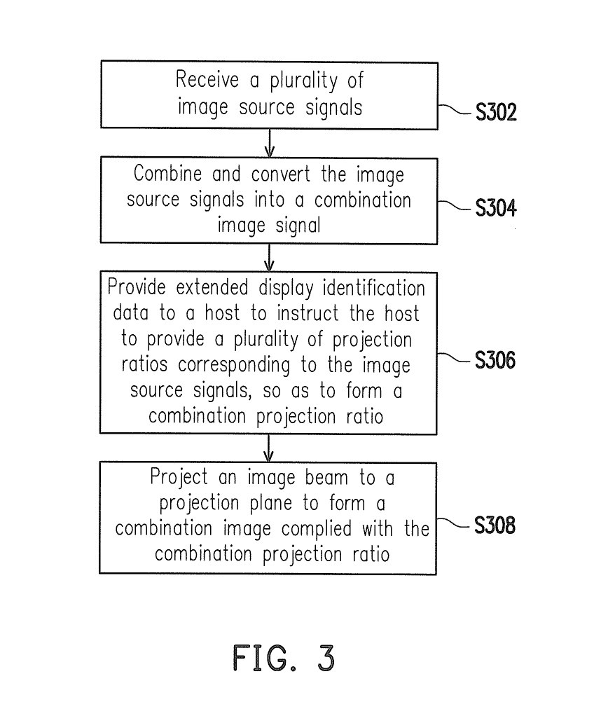

FIG. 2-3 is a schematic diagram of another projection system according to the embodiment of the invention. Referring to FIG. 2-3, the projection system of the embodiment further includes a touch device, and the touch device includes a detection light source L1 and an invisible light sensing unit 204. The projection device 104 is coupled to the host 102 for transmitting image information. The detection light source L1 is used for emitting an invisible light curtain, for example, an infrared laser curtain to cover the surface of the projection plane S1. The invisible light sensing unit 204 is coupled to the projection device 104, and the invisible light sensing unit 204 is located beside the projection device 104 or integrated within the projected device 104. In another embodiment, the invisible light sensing unit 204 can also be directly connected to the host 102, and the invisible light sensing unit 204 can sense the light blocked by a touch object (for example, a finger, a stylus or other object capable of blocking or reflecting the detection beams) or sense reflected lights of the detection beam reflected by the touch object, and the host 102 determines a touch position of the touch object according to a sensing result of the invisible light sensing unit 204.

Moreover, the projection system of the embodiment further includes a light emitting unit 206, which is, for example, a laser pen capable of emitting a coaxial dual-wavelength light, i.e. simultaneously emitting a visible light and an invisible light. The visible light emitted by the light emitting unit 206 fauns a light spot P1 on the projection plane S1 to indicate a position pointed by the light emitting unit 206. A light spot (a position thereof is the same to that of the light spot P1) Ruined on the projection plane by the invisible light emitted by the light emitting unit 206 can be sensed by the invisible light sensing unit 204, and the host 102 determines a position of the light spot P1 according to a sensing result of the invisible light sensing unit 204, and executes a corresponding operation (for example, to display a moving trajectory of the of the light spot P1 on the projection plane, or execute a corresponding touch operation according to a position of the light spot P1). In this way, when the user uses the light emitting unit 206 to perform a remote operation, the other viewers can also view the position and a motion of the light spot P1, so as to facilitate multiple people to discuss in collaboration. The detection beam and the invisible light are, for example, infrared light or other invisible light, and the light sensing unit 202 is, for example, an infrared camera or other light sensors capable of detecting the corresponding invisible light.

FIG. 2-4 is a schematic diagram of another projection system according to the embodiment of the invention. Referring to FIG. 2-4, compared to the embodiment of FIG. 2-2, descriptions of the same parts are not repeated, and a difference there between is that the projection device 104 receives the combination image signal from the image source signal combination unit 116 to project a combination image corresponding to the combination image signal, so as to form a first image Image1 and a second image Image2 on the projection plane S1. Referring to related descriptions of FIG. 1-1 to FIG. 1-4, a touch region and a non-touch region are defined on the projection plane. The non-touch region displays the first image Image1, and the touch region displays the second image Image2, where the first image Image1 and the second image Image2 correspond to the image source signals.

In this way, the projection system has a touch function, which further riches the application of the projection system. For example, in a classroom, a plurality of projection regions corresponding to different image source signals can be projected on the projection plane, and teachers and students can directly perform touch operations on different projection regions, for example, the teacher gives a lesson, explains an exercise question, or a student presents an answer, etc., so as to implement the teaching activity in a more intuitive and convenient way. The projection image of a part of projection regions can be a blank image to facilitate the user to perform writing. For another example, when the touch function of the projection device is applied in a shop window, a potential consumer can click and select to view a required product catalog and style. In this way, a more convenient service is provided to the consumer.

FIG. 3 is a flowchart illustrating a projection method of a projection system according to an embodiment of the invention. Referring to FIG. 3, the projection method of the aforementioned projection system includes following steps. First, a plurality of image source signals are received (step S302). Then, the image source signals are combined and converted into a combination image signal (step S304), where a combination image corresponding to the combination image signal is combined by a plurality of images corresponding to the image source signals. Then, extended display identification data (EDID) is transmitted to a host to instruct the host to provide a plurality of projection ratios corresponding to the image source signals, so as to form a combination projection ratio (step S306). Then, a light valve is set to a mode corresponding to the combination projection ratio according to the resolution mode lookup table. Then, an integration rod is provided and disposed on a transmission path of the illumination beam, where the integration rod has a light incident end and a light emitting end, and an area of the light incident end is greater than or equal to an area of the light emitting end. The illumination beam enters the integration rod through the light incident end and leaves the integration rod through the light emitting end, and an aspect ratio of the light emitting end is complied with the combination projection ratio, where the combination projection ratio is, for example, between 2.3:1 and 2.7:1. Then, the light valve is controlled to convert the illumination beam into the image beam according to the combination image signal, where the light valve has a light receiving surface, and the light receiving surface can convert the illumination beam leaving the integration rod into the image beam. When the light value is set to the mode corresponding to the combination projection ratio, a part of region of the light receiving surface can be disabled, so that a non-disabled region of the light receiving surface is complied with the combination projection ratio. Finally, the image beam is projected to a projection plane to form a combination image complied with the combination projection ratio (step S308).

In summary, in the embodiment of the invention, a plurality of image source signals are converted into the combination image signal, and the illumination beam is output through the integration rod with the aspect ratio of the light emitting end thereof complying with the ultrawide projection ratio, and the EDID is provided to the host to instruct the host to provide the combination image signal corresponding to the ultrawide projection ratio. Meanwhile, the light valve is set to the mode corresponding to the ultrawide projection ratio, and the light valve is controlled by the combination image signal to convert the illumination beam into the image beam capable of projecting the ultrawide projection image complied with the ultrawide projection ratio, so as to provide the ultrawide projection image without compression distortion.

Moreover, the projection method of the projection system of the invention further includes defining the projection plane into a touch region and a non-touch region, where the combination image projected to the projection plane is divided into a first image and a second image respectively corresponding to the non-touch region and the touch region, and the first image and the second image correspond to a plurality of image source signals.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A projection system, comprising:
a projection plane;
an image source signal combination unit, adapting to couple to a host, and receiving a plurality of image source signals from the host, combining and converting the image source signals into a combination image signal; and
a projection device, comprising:
a light source, providing an illumination beam;
a light valve, disposed on a transmission path of the illumination beam, and having a light receiving surface, wherein the light receiving surface converts the illumination beam into an image beam for projecting to the projection plane to form a combination image, wherein the combination image corresponds to the combination image signal;
a storage unit, storing an extended display identification data and a resolution mode lookup table; and
a control unit, coupled to the light valve, the storage unit and the image source signal combination unit, and adapted to provide the extended display identification data to the host to instruct the host to provide a plurality of projection ratios corresponding to the image source signals.

2. The projection system as claimed in claim 1, wherein the image source signal combination unit combines the projection ratios corresponding to the image source signals to form a combination projection ratio, and controls the light valve to convert the illumination beam into the image beam according to the combination image signal, and the control unit further sets the light value to a mode corresponding to the combination projection ratio according to the resolution mode lookup table, so that the combination image is complied with the combination projection ratio.

3. The projection system as claimed in claim 2, wherein the projection device further comprises an integration rod disposed on the transmission path of the illumination beam and located between the light source and the light valve, and the integration rod having a light incident end and a light emitting end, wherein the illumination beam enters the integration rod through the light incident end and leaves the integration rod through the light emitting end, and an aspect ratio of the light emitting end of the integration rod is complied with the combination projection ratio.

4. The projection system as claimed in claim 3, wherein an area of the light incident end of the integration rod is greater than or equal to an area of the light emitting end.

5. The projection system as claimed in claim 2, wherein the combination projection ratio is between 2.3:1 and 2.7:1.

6. The projection system as claimed in claim 2, wherein when the light value is set to a mode corresponding to the combination projection ratio, the control unit disables a part of region of the light receiving surface, so that a non-disabled region of the light receiving surface is complied with the combination projection ratio, and the non-disabled region of the light receiving surface is used for receiving the illumination beam from the light emitting end.

7. The projection system as claimed in claim 1, wherein the combination image is combined by a plurality of images corresponding to the image source signals.

8. The projection system as claimed in claim 1, further comprising:
a touch module, comprising:
at least one detection light source, emitting a detection beam to detect the projection plane; and
a light sensing unit, coupled to the host, and sensing a reflected light of the detection beam reflected by a touch object, and the host determines a touch position of the touch object according to the reflected light.

9. The projection system as claimed in claim 8, wherein a touch region and a non-touch region is defined on the projection plane.

10. The projection system as claimed in claim 9, wherein the non-touch region displays a first image projected by the projection device, and the touch region displays a second image projected by the projection device, wherein the first image and the second image correspond to the image source signals.

11. The projection system as claimed in claim 1, further comprising:
a light emitting unit, simultaneously emitting a visible light and an invisible light to form a light spot on the projection plane; and
an invisible light sensing unit, coupled to the host, and sensing the invisible light, wherein the host determines a position of the light spot according to a sensing result of the invisible light sensing unit.

12. The projection system as claimed in claim 1, wherein the projection device is further connected to a cloud server through a network interface.

13. The projection system as claimed in claim 1, wherein the projection plane is a screen, and the screen comprises a Fresnel lens film or smart glass.

14. The projection system as claimed in claim 1, wherein the light valve is a digital micromirror device or a liquid crystal on silicon panel.

15. The projection system as claimed in claim 1, wherein the projection device is spaced from the projection plane by a distance of 30-50 cm, and the combination image projected by the projection device is above 130 inches.

16. A projection method, comprising:
receiving a plurality of image source signals;
combining and converting the image source signals into a combination image signal;
providing extended display identification data to a host to instruct the host to provide a plurality of projection ratios corresponding to the image source signals, so as to form a combination projection ratio; and
projecting an image beam to a projection plane to form a combination image complied with the combination projection ratio.

17. The projection method as claimed in claim 16, further comprising setting a light valve to a mode corresponding to the combination projection ratio according to a resolution mode lookup table.

18. The projection method as claimed in claim 17, further comprising:
disposing an integration rod on a transmission path of an illumination beam, wherein the integration rod has a light incident end and a light emitting end, the illumination beam enters the integration rod through the light incident end and leaves the integration rod through the light emitting end; and
controlling the light valve to convert the illumination beam leaving the integration rod into an image beam according to the combination image signal.

19. The projection method as claimed in claim 16, further comprising providing the combination image corresponding to the combination image signal, wherein the combination image is formed by combining a plurality of images corresponding to the image source signals.

20. The projection method as claimed in claim 18, wherein an area of the light incident end is greater than or equal to an area of the light emitting end, the illumination beam enters the integration rod through the light incident end, and leaves the integration rod through the light emitting end, and an aspect ratio of the light emitting end is complied with the combination projection ratio.

21. The projection method as claimed in claim 16, wherein the combination projection ratio is between 2.3:1 and 2.7:1.

22. The projection method as claimed in claim 16, wherein the light valve has a light receiving surface, the light receiving surface converts the illumination beam into the image beam, when the light valve is set to a mode corresponding to the combination projection ratio, a part of region of the light receiving surface is disabled, so that a non-disabled region of the light receiving surface is complied with the combination projection ratio.

23. The projection method as claimed in claim 16, further comprising:
providing the projection plane, wherein the projection plane is defined into a touch region and a non-touch region, the combination image projected to the projection plane is divided into a first image and a second image respectively corresponding to the non-touch region and the touch region, and the first image and the second image correspond to the image source signals.
